(19) United States
(12) Patent Application Publication
(10) Pub. No.: US 2014/0080646 A1
(43) Pub. Date: Mar. 20, 2014

(54) MECHANICAL SYSTEM WITH ONE-WAY CLUTCH, ALTERNATOR AND METHOD OF MANUFACTURING SUCH A SYSTEM

(71) Applicants: Eve Goujon, Wurzburg (FR); Nadia Planchenault, Saint-Antoine-du-Rocher (FR)

(72) Inventors: Eve Goujon, Wurzburg (FR); Nadia Planchenault, Saint-Antoine-du-Rocher (FR)

(73) Assignee: AKTIEBOLAGET SKF, Goteborg (SE)

(21) Appl. No.: 14/017,668

(22) Filed: Sep. 4, 2013

(30) Foreign Application Priority Data
Sep. 4, 2012 (FR) 1258243

(51) Int. Cl. F16D 41/00; F16H 55/36

(52) U.S. Cl. CPC F16D 41/00; F16H 55/36
USPC 474/166; 192/41 R; 29/893.1

(57) ABSTRACT

The present invention relates to a mechanical system with one-way clutch, for example a pulley for a motor vehicle alternator, comprising a first element and a second element able to move one relative to the other. These elements delimit an annular housing including a one-way clutch device and at least one rolling bearing positioned beside the one-way clutch device. The mechanical system is characterized in that the one-way clutch device is lubricated by a lubricant of a first type, in that the rolling bearing or bearings are lubricated by at least one lubricant of a second type, and in that the lubricant of the first type and the lubricant of the second type are different from and compatible with one another. The invention also relates to an alternator comprising such a system configured as a pulley, and to a method of manufacturing such a mechanical system.

### CROSS-REFERENCE TO RELATED APPLICATION

This application is a United States Non-Provisional Utility Patent Application claiming the benefit of French Patent Application Number FR1258243 filed on 4 Sep. 2012, which is incorporated herein in its entirety.

### TECHNICAL FIELD

The field of the invention is that of the lubrication of mechanical systems, notably alternator pulleys. The present invention relates to a mechanical system with a one-way clutch, for example to a motor vehicle alternator pulley. The invention also relates to an alternator comprising such a mechanical system, configured as a pulley with a one-way clutch. The invention further relates to a method of manufacturing such a mechanical system.

### BACKGROUND ART

In the known way, a transmission belt drives an external rim of an alternator pulley, driving an internal hub. This pulley is subjected to numerous variations in speed and torque when in service, notably because of the acyclic operation of the engine. There are various means in existence for smoothing these variations in speed and torque applied to the pulley, for example by fitting a one-way clutch (OWC) device, also referred to as a free wheel, between the hub and the rim. In one direction of rotation, the one-way clutch device transmits torque from the rim to the hub of the pulley, whereas in the other direction of rotation, the pulley operates as a free wheel.

WO-A-2011 079 963 describes a mechanical system of motor vehicle alternator pulley type, comprising two ball bearings and a one-way clutch device which are arranged between a hub and a rim. Although the operating conditions of the various parts of the mechanical system, notably their service temperature, are not the same, the same grease is used for lubricating them. This grease is selected with care in order to obtain effective lubrication of the various parts regardless of their respective operating conditions, throughout the life of the system, without disassembly.

As an alternative, such a mechanical system may be provided with sealing members arranged on the sides of the rolling bearings, on either side of the one-way clutch. The various parts are then isolated from one another in a sealed manner, so that two specific lubricants can be used within the mechanical system, without the risk of these lubricants mixing. However, the use of sealing members increases the cost and size of the system.

### DISCLOSURE OF INVENTION

It is an object of the present invention to propose an improved mechanical system.

To this end, a subject of the invention is a mechanical system with one-way clutch, for example a pulley for a motor vehicle alternator, comprising a first element and a second element which are able to move one relative to the other in rotation about a central axis and delimit an annular housing radially with respect to the central axis, the annular housing including a one-way clutch device able to engage the first element with the second element that is able to move in terms of rotation in a first direction of rotation about the central axis and to disengage in a second direction of rotation that is the opposite of the first direction of rotation, and at least one rolling bearing positioned beside the one-way clutch device along the central axis. This mechanical system is characterized in that the one-way clutch device is lubricated by a lubricant of a first type, in that the rolling bearing or bearings are lubricated by at least one lubricant of a second type, and in that the lubricant of the first type and the lubricant of the second type are different from and compatible with one another.

Thus, the invention makes it possible to improve the life of the mechanical system and of its constituent elements. In particular, the lives of, on the one hand, the rolling bearings and, on the other hand, the one-way clutch, are improved through the use of two specific lubricants which are optimized for their operating conditions. In this particular instance, the compatibility of the two lubricants is that when these two lubricants are in contact with one another before the mechanical system enters service or while it is in service, neither of the two lubricants experiences appreciable deterioration of any of its physico-chemical properties. By ensuring that these lubricants are compatible with one another in service, the system does not necessarily require members that provide sealed isolation between the rolling bearings and the clutch. Because the lubrication of the rolling bearings has improved, the system also no longer requires a special coating such as a diamond-like carbon coating (DLC) at the interfaces between the moving elements, thus likewise reducing its cost.

According to other advantageous features of the invention, considered in isolation or in combination:
the lubricant of the first type and the lubricant of the second type are in contact at least at an interface zone. Thus the present invention overcomes a preconceived idea of the prior art whereby it is disadvantageous to use two different lubricants without any physical separation in case the lubricants mix and lose their lubricating properties.
the or each rolling bearing is provided with a sealing member on the side axially away from the one-way clutch device and has no sealing member on the side axially facing towards the one-way clutch device.
the rolling bearing or bearings define a bearing chamber between two raceways, in which chamber at least one row of rolling elements is inserted, the said bearing chamber being isolated from the outside of the rolling bearing by sealing means so that the lubricant of the first type and the lubricant of the second type are isolated from one another.
the lubricant of the first type is a first grease and the lubricant of the second type is a second grease.
out of the first grease and the second grease at least one has an NLGI grade strictly higher than 1 when the mechanical system is in service.
the lubricant of the first type is an oil and the lubricant of the second type is a grease.
the grease has an NLGI grade strictly higher than 1 when the system is in service.

Another subject of the invention is an alternator comprising such a mechanical system, configured as a pulley with a one-way clutch.

Another subject of the invention is a method of manufacturing such a mechanical system. The method comprises steps consisting in:
a) determining operating conditions of the mechanical system, including:
   a1) determining operating conditions of the one-way clutch device;
   a2) determining operating conditions of the or each rolling bearing;
b) choosing the lubricant of the first type and the lubricant of the second type which are different from and compatible with each other, including:
   b1) choosing the lubricant of the first type, suited to the operating conditions of the one-way clutch device;
   b2) choosing the lubricant of the second type, suited to the operating conditions of the rolling bearing or bearings;
   b3) checking the compatibility of the lubricant of the first type and of the lubricant of the second, either experimentally or from a pre-established database;
c) lubricating the mechanical system, including:
   c1) lubricating the one-way clutch device with the lubricant of the first type;
   c2) lubricating the rolling bearing or bearings with at least the lubricant of the second type.

### BRIEF DESCRIPTION OF DRAWINGS

The invention will be better understood from reading the description which will follow, given solely by way of non-limiting example and made with reference to the attached drawings in which:

FIG. 1 is a view in axial section of a mechanical system according to the invention, of the alternator pulley type comprising rolling bearings and a one-way clutch device which are arranged between a rim and a hub;

FIG. 2 is a perspective view of the one-way clutch device of FIG. 1; and

FIG. 3 is a larger-scale view of detail III of FIG. 1.

### DETAILED DESCRIPTION

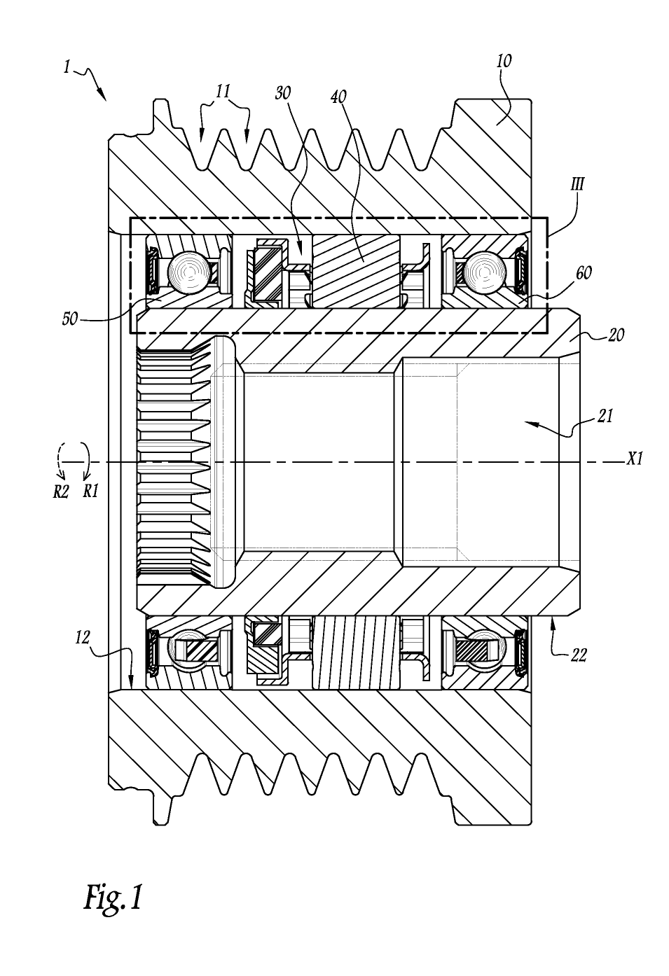

FIGS. 1 to 3 depict a pulley 1 according to the invention. This pulley 1 is designed to be fitted to a motor vehicle alternator which, for the sake of simplicity, has not been depicted.

The pulley 1 is centred on a central axis X1 and comprises an external rim 10, an internal hub 20, a housing 30 of annular profile delimited radially between the rim 10 and the hub 20, and a one-way clutch device 40 and two rolling bearings 50 and 60 which are arranged in the housing 30.

The rim 10 and the hub 20 are able to move relative to one another in rotation about the central axis X1. The rim 10 comprises external grooves 11 configured to partially house a transmission belt, whereas the hub 20 comprises an internal bore 21 configured to receive an alternator shaft, the belt and the shaft having not been depicted for the sake of simplicity. The rim 10 also comprises an internal cylindrical bore 12, while the hub 20 comprises an external cylindrical bearing surface 22, together delimiting the housing 30.

The device 40 arranged in the housing 30 allows the rim 10 to be engaged with the hub 20 for rotation in a first direction of rotation R1 about the central axis X1 and, conversely, to disengage the rim 10 from the hub 20 in a second direction of rotation R2 that is the opposite of the first direction of rotation R1.

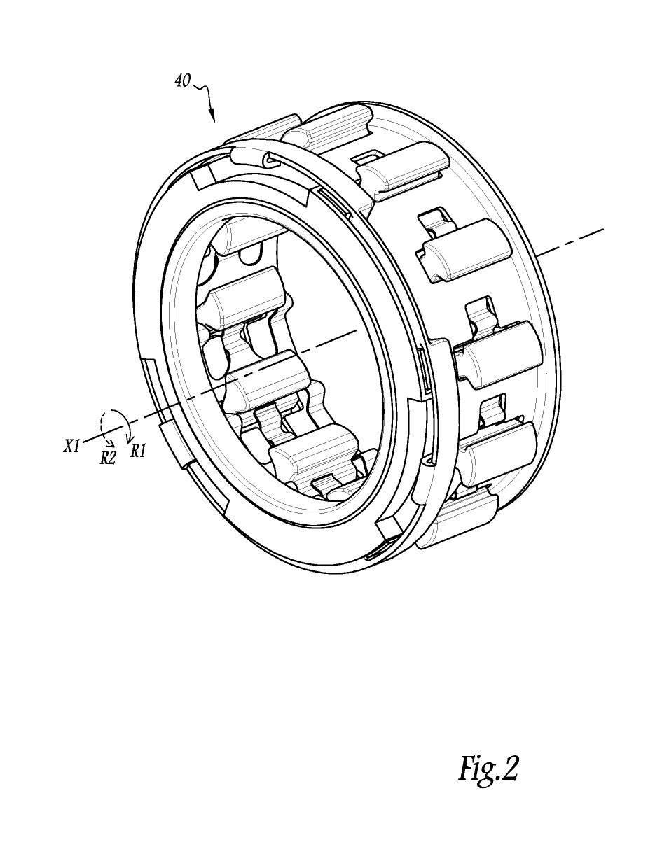

An example of a one-way clutch device 40 like the one depicted by itself in FIG. 2 is described in document WO-A-2011 079 963.

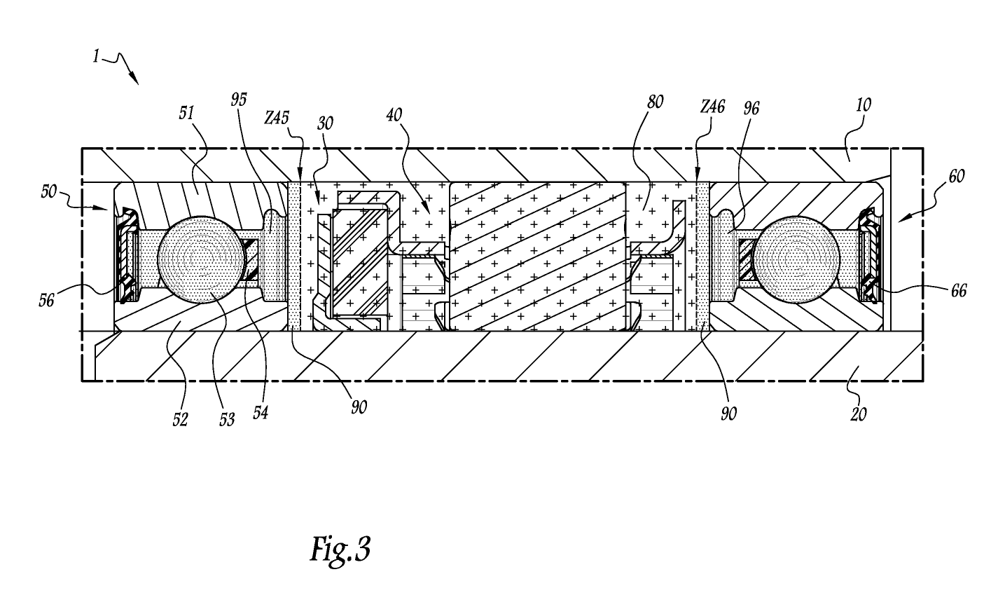

The rolling bearings 50 and 60 are positioned beside the device 40, on either side of this device along the central axis X1, in the housing 30. As shown in FIG. 3, the rolling bearing 50 comprises an outer ring 51, an inner ring 52, rolling elements 53 of the ball type held by a cage 54 and a seal 56. The rolling bearing 60 is similar to the rolling bearing 50 and notably comprises a seal 66. The seals 56 and 66 can be qualified as external lateral seals along the axis X1, with respect to the housing 30 and to the device 40, because they are situated on the outside of the rolling bearings 50 and 60 in relation to the device 40. The rolling bearings 50 and 60 do not have any internal lateral seals interposed between them and the device 40.

The pulley 1 and its constituent elements which are arranged in the housing 30 are lubricated so as to reduce heating and friction in service, thus increasing their life. The choice of lubricant depends on the operating conditions of these constituent elements, particularly the device 40 and the rolling bearings 50 and 60. These operating conditions include several variable parameters, such as the rotational speed about the axis X1, the loads and the temperatures to which they are subjected in service, and the maximum expected life of the pulley 1.

In particular, the lubricant may be an oil or a grease. One main characteristic of the lubricant is its viscosity, which is dependent on its temperature. The lubricating oil is made up of a base and, for preference, one or more additives. The base may be a mineral or synthetic oil, preferably a synthetic one for applications at temperatures in excess of 100° C. The lubricating grease is made up of a base oil, of a thickener, and preferably of one or more additives. The additives allow certain properties of the lubricant, such as its viscosity, its resistance to abrasion or to high pressure to be modified, or alternatively allow the behaviour of the lubricant to be adapted to suit a specific application, having specific operating conditions.

The known mechanical systems, like the one described in WO-A-2011 079 963, incorporate a single lubricant, generally a lubricating oil. The operation of these systems is satisfactory but can be improved. Specifically, the lubrication is then adapted to suit the system as a whole, but is not optimized specifically for each of its constituent elements.

In the context of the present invention, as shown in FIG. 3, the one-way clutch device 40 is lubricated by a lubricant of a first type 80, whereas the rolling bearings 50 and 60 are lubricated by a lubricant of a second type 90. In particular, the lubricant of the first type 80 and the lubricant of the second type 90 are different from and compatible with one another in service.

In order to allow the pulley 1 to enter service, the rolling bearing 50 is packed with a first quantity 95 of lubricant 90, while the rolling bearing 60 is packed with a second quantity 96 of lubricant 90. The device 40 is filled with a greater quantity of lubricant 80, because it is larger in size than the bearings 50 and 60. The lubricant 80 is in contact, on the one hand, with the quantity 95 of lubricant 90 at an interface zone Z45 situated between the device 40 and the rolling bearing 50 and, on the other hand, with the quantity 96 of lubricant 90 at an interface zone Z46 situated between the device 40 and the rolling bearing 60. The interface zones Z45 and Z46 are indicated schematically by dotted lines in FIG. 3, although their actual profile may vary, particularly in service.

The lubricants 80 and 90 are chosen to be different so that they can be optimized for the specific operating conditions of the element 40, 50 or 60 that they lubricate. Specifically, the device 40 has a limited rotation during the course of time in comparison with the rolling bearings 50 and 60, but is subjected to greater loads. If the lubricant 90 for the rolling bearings 50 and 60 is incorrectly specified, the film of lubricant 90 between the rings 51 and 52 and the rolling elements 53 is liable to be insufficient, or even non-existent, thus increasing the wear of the rolling bearings 50 and 60 and reducing their life. For preference, the lubricant 90 has a viscosity in excess of 50 centistoke (cSt) at 40° C.

By way of non-limiting example, the overall operating conditions for pulley 1 are as follows: the temperature in the housing 30 is between −40° C. and +150° C., while the maximum life expected of the pulley 1 is equivalent to the vehicle covering 300 000 kilometres.

The lubricants 80 and 90 are also chosen to be compatible with one another, before the pulley 1 enters service and more particularly when it is in service. Compatibility between two lubricants means that when the two lubricants are in contact with one another before the pulley 1 enters service or while it is in service, neither of the two lubricants experiences any appreciable degradation of any of its physico-chemical properties. More specifically, the absence of notable degradation in a physico-chemical property can be defined by its remaining in a range corresponding to ±5% of its initial value, and preferably ±2% of its initial value.

According to a first compatibility criterion, the lubricants 80 and 90 have to be chemically compatible, which means that one of the components or the components of one of the lubricants 80 and 90 must not chemically degrade one of the components or the components of the other lubricant 80 or 90 either before the pulley 1 enters service or while it is in service.

According to a second compatibility criterion, the lubricants 80 and 90 need to be physically compatible, which means to say that neither of the two lubricants must undergo a critical change in consistency when the two lubricants are in contact with one another, in the zones Z45 and Z46, before the pulley 1 enters service or while it is in service. Specifically, a change in consistency could carry the risk of culminating in, amongst other things, a change in viscosity and a loss in lubricating effectiveness. In addition, all or some of a lubricant 80 or 90 may get into a zone for which it is not intended and thus adversely affect system performance.

The consistency of a grease is defined by standard NFT 60-132, which corresponds to the standards ISO 2137 and ASTM-D 217, as being the resistance of this grease to deformation, following a preliminary mixing operation, under the penetrative action of a conical plunger of determined shape and determined mass, at 25° C., over a time interval of 5 seconds. This penetration is referred to as the worked penetration because of the preliminary mixing operation, and is measured in tenths of a millimetre. This consistency measurement can be compared, to a certain extent, to a cone penetration hardness test of a metal substrate.

An American organization, the National Lubricating Grease Institute, or NLGI, has established a classification of greases whereby the greases are classified according to their consistency. As shown in Table 1 below, each NLGI grade is defined by a range of worked penetrability at 25° C. values.

TABLE 1

| | Worked penetration at | |
|---|---|---|
| | 25° C. in tenths of a | |
| NLGI Grade | millimetre | Consistency |
| 000 | 445-475 | Very fluid |
| 00 | 400-430 | Fluid |
| 0 | 355-385 | Semi-fluid |
| 1 | 310-340 | Very soft |
| 2 | 265-295 | Soft |
| 3 | 220-250 | Normal |
| 4 | 175-205 | Semi-hard |
| 5 | 130-160 | Hard |
| 6 | 85-115 | Very hard |

According to a first embodiment of the system 1, the lubricant of the first type is a first grease 80 and the lubricant of the second type is a second grease 90 different from the first grease 80.

When the greases 80 and 90 are introduced into the housing 30 of the pulley 1, their NLGI grade is generally comprised between around 2 and 3, which corresponds to a relatively pasty appearance. When they are initially brought into contact, at the zones Z45 and Z46, the respective consistencies of the greases 80 and 90 may be modified by physico-chemical interactions between their components: base oil, additives and especially thickener. Thereafter, when the pulley 1 is in service, the consistency of each of the lubricating greases 80 or 90 is likely to evolve over time, notably under the effect of variations in temperature and/or load applied to the elements 40, 50 and/or 60, with a phenomenon of hardening, softening or degradation.

For preference, out of the first grease 80 and the second grease 90 at least one has an NLGI grade strictly higher than 1 when the system 1 is in service. As an alternative, both greases 80 and 90 may have an NLGI grade strictly higher than 1 when the system 1 is in service.

According to a second embodiment of the system 1, the lubricant of the first type is an oil 80 and the lubricant of the second type is a grease 90.

The oil 80 and the grease 90 need to be compatible because of the risk of mixing in the zones Z45 and Z46. Further, the quantity of oil 80 initially introduced into the housing 30 of the pulley 1 needs to be metered with care. The oil 80 has a satisfactory distribution and fluidity in the device 40, while the grease 90 has a viscosity that is satisfactory for lubricating the rolling bearings 40 and 50. For preference, the grease 90 has an NLGI grade strictly higher than 1 when the system 1 is in service.

According to a third embodiment of the system 1, the device 40 is packed with a lubricant of a first type 80, the rolling bearing 50 is packed with a lubricant of a second type 95, whereas the rolling bearing 60 is packed with a lubricant of a third type 96. This embodiment is of benefit when the rolling bearings 50 and 60 are not subjected to exactly the same operating conditions, for example load and/or temperature.

In other words, in the context of the present invention, the rolling bearings 50 and 60 are lubricated by at least one lubricant of a second type 90, and possibly by two different lubricants 95 and 96.

For preference, whatever the embodiment, the system 1 comprises no sealed separation member, such as a seal, between the device 40 and the rolling bearings 50 and 60. Advantageously, the lubricants 80 and 90 do not mix because of the differences in density and viscosity between them. If the lubricants 80 and 90 are likely to mix, their compatibility means that no member separating them is required. The lubricants 80 and 90 maintain their lubricating properties, which are optimized for the element 40, 50 or 60 to which they are applied, when the pulley 1 is in use. In addition, the cage 54 of the rolling bearing 50 forms a labyrinth seal for the lubricant 95, and the same is true of the rolling bearing 60 and its cage.

The invention is not restricted to an alternator pulley comprising a hub and a rim. Specifically, the invention may be applied to any type of mechanical system 1 comprising a first element 10 and a second element 20 which are able to move relative to one another in rotation about a central axis X1 and between which a one-way clutch device 40 and at least one rolling bearing 50 are arranged.

One example of a method of manufacturing a mechanical system 1 according to the invention is detailed hereinbelow.

The method comprises a step a) consisting in determining the operating conditions of the mechanical system 1. In particular, step a) comprises a sub-step a1) consisting in determining the operating conditions of the one-way clutch device 40 and a sub-step a2) consisting in determining the operating conditions of the or each rolling bearing 50 and/or 60. Steps a1) and a2) may be simultaneous or follow on from one another in any order. In certain instances, the operating conditions of the system 1 are known by experience and require no testing to determine them. In other instances, the system 1 is new and its operating conditions, for example the temperatures it reaches in service, can be determined on test rig, by numerical simulation and/or by any other suitable means.

The method comprises a step b) that consists in choosing the lubricant of the first type 80 and the lubricant of the second type 90, which are different from and compatible with each other. In particular, step b) comprises a sub-step b1) consisting in choosing the lubricant 80 suited to the operating conditions of the device 40, a sub-step b2) consisting in choosing the lubricant 90 suited to the operating conditions of the rolling bearing or bearings 50 and/or 60, and a sub-step b3) consisting in checking the compatibility of the lubricant 80 and of the lubricant 90, either experimentally, or from a pre-established database. For preference, in step b3), the use of a database listing compatibility between various types of greases, such as tables 2 and 3 above for example, makes the choice of lubricants 80 and 90 in step b) easier. As an alternative, in step b3) an experimental check of compatibility between the lubricants 80 and 90 can be carried out for example on test rig, under the operating conditions of the system 1. Steps b1), b2) and b3) may follow on from one another quite quickly, depending on whether step b3) is performed experimentally or by consulting a database. Steps b1), b2) and b3) may be iterative if the first choice of lubricants proves to be incorrect.

The method also comprises a step c) which consists in lubricating the mechanical system 1, after its various constituent elements 10, 20, 40, 50 and 60 have been assembled, before this system 1 enters service. In particular, step c) comprises a step c1) that consists in lubricating the device 40 with the lubricant 80 and a step c2) that consists in lubricating the rolling bearing or bearings 50 and/or 60 with at least the lubricant 90, or even two different lubricants 95 and 96, one for each rolling bearing 50 or 60.

The method comprises at least steps a), b) and c), which are preferably performed in succession. The operating conditions of the system 1 are known from step a), then the lubricants 80 and 90 are chosen in step b), then the system is lubricated in step c).

When the system 1 is new and its operating conditions are unknown, steps a) and b) may comprise a test or successive tests to make it possible to determine both the operating conditions of the system 1 and the behaviour of the lubricants 80 and 90 chosen as a first approximation, notably the compatibility between them. Steps a) and b) can then, at least in part, be performed simultaneously and, if need be, repeated.

As an alternative form that has not been depicted, the system 1 comprises a single rolling bearing 50 arranged in the housing 30 with the device 40.

According to another alternative form that has not been depicted, the rolling bearing 50 and/or 60 comprises no external lateral sealing member 56 or 66. For example, the mechanical system 1 may be placed in a bath of lubricant 90 in which the rolling bearings 50 and 60 are bathed.

According to another alternative form that has not been depicted, the zone Z45 and/or the zone Z46 may be provided with a sealing member, preferably situated between the bearing rings 51/52 and/or 61/62. In this case, the rolling bearing or bearings 50 and 60 define a bearing chamber between two raceways, in which chamber at least one row of rolling elements 53 or 63 is inserted, the said bearing chamber being isolated from the outside of the rolling bearing by sealing means such that the lubricants 80 and 90 are not in contact. In other words, the lubricants 80 and 90 are isolated from one another by the sealing means. Even in this configuration, the system 1 according to the invention is such that the lubricants 80 and 90 are chosen to be different from and compatible with each other.

Furthermore, the technical features of the various embodiments can be combined with one another in full, or at least in the case of some of them. Thus, the mechanical system 1 can be adapted in terms of cost and of performance.

1. A mechanical system (1) with a one-way clutch, comprising:
a first element (10) and a second element (20) able to move one relative to the other in rotation about a central axis (X1) and delimit an annular housing (30) radially with respect to the central axis (X1), the annular housing (30) including:
a one-way clutch device (40) able to engage the first element (10) with the second element (20) and able to move in terms of rotation in a first direction of rotation (R1) about the central axis (X1) and to disengage in a second direction of rotation (R2) that is the opposite of the first direction of rotation (R1), and
at least one rolling bearing (50, 60) positioned beside the one-way clutch device (40) along the central axis (X1); wherein
the one-way clutch device (40) is lubricated by a lubricant of a first type (80), wherein
the rolling bearing or bearings (50, 60) are lubricated by at least one lubricant of a second type (90), and wherein
the lubricant of the first type (80) and the lubricant of the second type (90) are different from and compatible with one another.

2. The mechanical system according to claim 1, wherein the lubricant of the first type (80) and the lubricant of the second type (90) are in contact at least at an interface zone (Z45, Z46).

3. The mechanical system according to claim 1, wherein each rolling bearing (50, 60) is provided with a sealing member (56, 66) on the side axially away from the one-way clutch device (40) and has no sealing member on the side axially facing towards the one-way clutch device (40).

4. The mechanical system according to claim 1, wherein the rolling bearing or bearings (50, 60) define a bearing chamber between two raceways, in which chamber at least one row of rolling elements (53, 63) is inserted, the said bearing chamber being isolated from the outside of the rolling bearing (50, 60) by sealing means so that the lubricant of the first type (80) and the lubricant of the second type (90) are isolated from one another.

5. The mechanical system according to claim 1, wherein the lubricant of the first type (80) is a first grease and the lubricant of the second type (90) is a second grease.

6. The mechanical system according to claim 5, wherein between the first grease (80) and the second grease (90) at least one has an NLGI grade strictly higher than 1 when the mechanical system (1) is in service.

7. The mechanical system according to claim 1, wherein the lubricant of the first type (80) is an oil and the lubricant of the second type (90) is a grease.

8. The mechanical system according to claim 7, wherein the grease (90) has an NLGI grade strictly higher than 1 when the system (1) is in service.

9. A vehicle alternator, comprising:
a mechanical system having a first element (10) and a second element (20) able to move one relative to the other in rotation about a central axis (X1) and delimit an annular housing (30) radially with respect to the central axis (X1), the annular housing (30) including:
a one-way clutch device (40) able to engage the first element (10) with the second element (20) and able to move in terms of rotation in a first direction of rotation (R1) about the central axis (X1) and to disengage in a second direction of rotation (R2) that is the opposite of the first direction of rotation (R1), and
at least one rolling bearing (50, 60) positioned beside the one-way clutch device (40) along the central axis (X1); wherein
the one-way clutch device (40) is lubricated by a lubricant of a first type (80), wherein
the rolling bearing or bearings (50, 60) are lubricated by at least one lubricant of a second type (90), wherein
the lubricant of the first type (80) and the lubricant of the second type (90) are different from and compatible with one another, and wherein
the mechanical system is configured as a pulley with a one-way clutch.

10. A method of manufacturing a mechanical system, comprising the steps of:
providing a first element (10) and a second element (20) able to move one relative to the other in rotation about a central axis (X1) and delimit an annular housing (30) radially with respect to the central axis (X1), the annular housing (30) including a one-way clutch device (40) able to engage the first element (10) with the second element (20) and able to move in terms of rotation in a first direction of rotation (R1) about the central axis (X1) and to disengage in a second direction of rotation (R2) that is the opposite of the first direction of rotation (R1), and at least one rolling bearing (50, 60) positioned beside the one-way clutch device (40) along the central axis (X1); wherein the one-way clutch device (40) is lubricated by a lubricant of a first type (80), wherein the rolling bearing or bearings (50, 60) are lubricated by at least one lubricant of a second type (90), and wherein the lubricant of the first type (80) and the lubricant of the second type (90) are different from and compatible with one another,
a) determining operating conditions of the mechanical system (1), including:
a1) determining operating conditions of the one-way clutch device (40);
a2) determining operating conditions of the or each rolling bearing (50, 60);
b) choosing the lubricant of the first type (80) and the lubricant of the second type (90) which are different from and compatible with each other, including:
b1) choosing the lubricant of the first type (80), suited to the operating conditions of the one-way clutch device (40);
b2) choosing the lubricant of the second type (90), suited to the operating conditions of the rolling bearing or bearings (50, 60);
b3) checking the compatibility of the lubricant of the first type (80) and of the lubricant of the second type (90), either experimentally or from a pre-established database; and
c) lubricating the mechanical system (1), including:
c1) lubricating the one-way clutch device (40) with the lubricant of the first type (80); and
c2) lubricating the rolling bearing or bearings (50, 60) with at least the lubricant of the second type (90).
